(19) United States
(12) Patent Application Publication
(10) Pub. No.: US 2004/0009345 A1
(43) Pub. Date: Jan. 15, 2004

(54) Process for manufacturing a tube laminate

(76) Inventor: Otto Hummel, Singen (DE)

Correspondence Address: FISHER, CHRISTEN & SABOL, 1725 K STREET, N.W., SUITE 1108, WASHINGTON, DC, 20006, US

(21) Appl. No.: 10/448,138

(22) Filed: May 30, 2003

(30) Foreign Application Priority Data
Jun. 13, 2002 (EP) 02405489.2

(51) Int. Cl. B44F 1/10

(52) U.S. Cl. 428/332; 264/509; 428/29

(57) ABSTRACT

In a process for manufacturing a multi-layer tube material having a barrier layer (12) situated between plastic layers (10, 14)—to hinder the passage of water vapor and gases—and featuring a pattern in one of the layers of the tube material micro-embossing created by micro-embossing (M) and producing a optical effect, the individual layers are joined to make a multi-layer tube material; in the said process one of the layers (12) in the form of a foil/film is embossed and joined up with the other layers thus forming the tube material. A multi-layer tube material manufactured using the that process exhibits a structure in which at least one single-layer or multi-layer plastic layer (10) which is transparent at least in some areas, a metal foil (12) with micro-embossing (M) on the side of the plastic layer (10), and at least one functional layer (14) in the form of a single-layer or multi-layer plastic layer.

The invention relates to a process for manufacturing a multi-layer tube material having a barrier layer that hinders the passage of water vapor and gases, which is situated between plastic layers, and exhibiting a pattern in one of the layers of the tube material, produced by an optical effect as a result of micro-embossing, in which process the individual layers are combined to make up the multi-layer tube material. Also within the scope of the invention are multi-layer tube materials manufactured using that process.

Known tubes for toothpaste and for cosmetics, pharmaceuticals and other high-grade products exhibit a tube body of a multi-layer material, so called tube laminate. In order to hinder the passage of water vapor and gases, the tube laminates are provided with a so-called barrier layer. Also known—with a view to producing a special design, but also to increase the security against counterfeit—it is known to provide an optical effect in the form of a hologram or a pattern having an appearance similar to a hologram by means of a pattern in the tube laminate created by micro-embossing.

Up to now, tube laminates with an integral hologram have been produced by incorporating a hologram substrate film in the multi-layer tube laminate. A significant disadvantage of this process lies in the poor bonding of the hologram substrate lacquer to the bonding agent employed in the manufacture of the tube laminates. The poor bonding leads to delamination of the individual layers of the tube laminate after only a short time.

The object of the invention is to provide a process for manufacturing a multi-layer tube laminate of the kind described at the start, with which the delamination observed in conventional hologram substrate films can be eliminated.

That objective is achieved by way of the invention in that one of the layers in the form of a film is embossed and bonded to the other layers to produce the tube laminate, whereby the micro-embossing is preferably carried out in such a manner that the embossed pattern leads to an optical hologram-type effect.

In a first version of the process according to the invention the film to be embossed is a metal foil, preferably an aluminum foil, serving as barrier layer.

A second version of the process according to the invention is such that the film to be embossed is a plastic film with barrier layer, preferably a ceramic coating of SiOₓ on one side, whereby the film is embossed on the opposite side from the barrier layer, and a layer of metal, preferably of aluminum, is provided on the embossed pattern.

In a third version of the process according to the invention the film to be embossed is a plastic film and a layer of metal, preferably an aluminum foil, is provided on the embossed pattern, whereby a metal foil, preferably a aluminum foil, is provided as barrier layer.

A multi-layer tube material manufactured according to the first version of the process is characterized preferably by way of the following layer structure:

at least one single-layer or multi-layer plastic layer which is transparent at least in some areas,

a metal foil with micro-embossing on the side of the plastic layer, and

at least one functional layer of a single-layer or multi-layer plastic layer.

A multi-layer tube material manufactured according to the second version of the process is characterized preferably by way of the following layer structure:

at least one single-layer or multi-layer plastic layer which is transparent at least in some areas,

a plastic film with micro-embossing and, on the embossed pattern, a layer of metal on the side of the plastic layer and with a barrier layer of SiOₓ on the side of the foil opposite that bearing the micro-embossing, and

at least one functional layer of single-layer or multi-layer plastic layer.

Preferred is the plastic layer bordering on the metallic layer a lacquer laminate layer or an extrusion laminate layer.

The barrier layer of SiOx is preferably provided with a bonding agent, preferably a chrome layer, and preferably an extrusion laminate layer is provided between the bonding agent and a functional layer.

A multi-layer tube material manufactured according to the third version of the process is characterized by way of the following layer structure:

at least one single-layer or multi-layer plastic layer which is transparent at least in some areas,

a micro-embossed plastic film and a layer of metal on the embossed pattern on the side of the plastic layer,

at least one functional layer of single-layer or multi-layer plastic layer and,

a metal foil, preferably an aluminum foil, as barrier layer, situated between the embossed pattern and the functional layer.

The plastic layer bordering on the metallic layer is preferably a lacquer laminate layer or extrusion laminate layer. Likewise, a lacquer laminate layer or an extrusion laminate layer is preferably provided between the plastic film with the embossed pattern and the metal foil and between the metal foil and a functional layer.

The plastic layer which is transparent at least in some areas forms the outer facing side of the tube body manufactured out of the tube material. Beams of light passing through the transparent areas strike the embossed pattern and produce the desired optical effect as a result of interference with the beams of light reflected from the metal layer bearing the embossed pattern. The plastic layer may be colored or printed on.

Suitable metal foils are, e.g., iron, copper, silver, gold and aluminum foil, whereby the last mentioned of these is preferred. The thickness of the foil is about 6 to 40 μm.

The plastic films to be embossed are, e.g., of polyamide, polyester, polyolefine, polyvinyl chloride or polycarbonate. The thickness of the plastic film is approx. between 7 and 100 μm. A metal layer deposited on the micro-embossed side of the plastic film as a reflecting or mirroring layer normally has a thickness of approx. 5 to 500 nm and may be created using known metallizing procedures, e.g., physical or chemical thin film deposition of iron, nickel, chromium, copper, silver, gold, aluminum, or another metal, deposited in vacuum, e.g., by sputtering.

The micro-embossing on the metal foil or on the plastic film is transferred directly to the foil/film by means of a corresponding negative using an embossing roll.

The plastic film acting as a substrate is coated with a ceramic layer of SiOx, where x represents a number between 0.9 and 2, preferably a number between 1.5 and 1.8 in order to achieve a good barrier action against water vapor and gases, e.g., electro-beam coating with a 50 to 150 nm thick layer of SiO_{1.8}. A bonding agent on the SiOx layer—in the form of a thin metal layer of, e.g., chromium, aluminum, nickel, titanium, iron or molybdenum—is preferably a monatomic layer with a thickness of about 0.1 to 0.5 nm. The preferred coating using chrome is deposited, e.g., using a sputtering cathode in an argon atmosphere.

Suitable plastics for the single-layer or multi-layer plastic layer forming the outside of the tube made using the tube material and for the functional layers made from a single-layer or multi-layer plastic layer and forming the inner facing side of tube bodies are preferably thermoplastics, in particular polyolefines, preferably polyethylenes, polypropylenes and copolymers with ethylene or propylene as one of the monomer constituents. Lacquer laminate coatings and extrusion laminate coatings also contain polyolefines or are made of copolymers of ethylene or polypropylene as one of the monomer constituents.

Further advantages, features and details of the invention are revealed in the following description of preferred tube laminates in connection with the drawing which shows schematically in

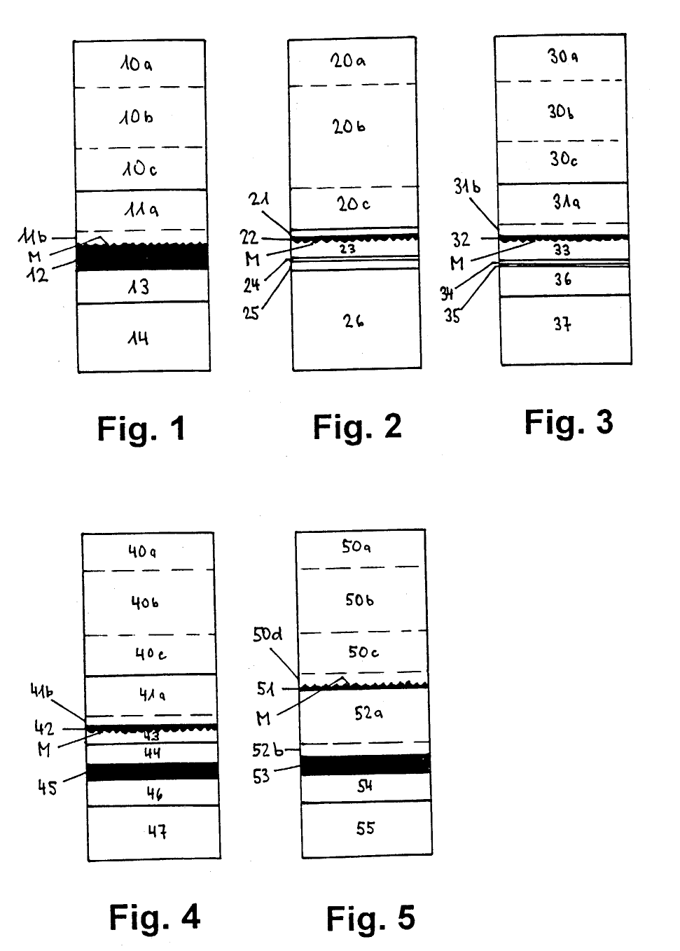

FIGS. 1 to 5 the structure of the tube laminates characterized in greater detail in the examples given.

The following abbreviations are used in the examples:

| | |
|---|---|
| PE | polyethylene |
| PET | polyethylene-terephthalate |
| LMDPE | linear medium-density polyethylene (0.926-0.940 g/cm³) |
| E | ethylene as monomer constituent in copolymers |
| AA | acrylic acid as monomer constituent in copolymers. |

### EXAMPLE 1

The tube laminate shown in cross-section in FIG. 1 exhibits the following structure from the outside of the tube to the inside of the tube:

| 10a, b, c | PE film, coextruded, transparent, 110 μm thick |
|---|---|
| 11a, b | PE laminate extruded layer, coextruded, transparent, 45/10 μm |
| | thick |
| 12/M | aluminum foil, 20 μm thick, micro-embossed, as barrier layer |
| 13 | E.AA copolymer laminate extruded layer, 30 μm thick |
| 14 | LMDPE film, 60 μm thick. |

### EXAMPLE 2

The tube laminate shown in cross-section in FIG. 2 exhibits the following structure from the outside of the tube to the inside of the tube:

| 20a, b, c | PE film, coextruded, transparent, 170 μm thick |
|---|---|
| 21 | PE laminate lacquer layer, 3 g/m³ |
| 22 | aluminum, 70 nm thick, coated by vapor deposition on the |
| | micro-embossing on the PET film 23 |
| 23M | micro-embossed PET film, 12 μm thick, |
| 24 | coating of SiO_{1.8}, 80 nm thick, deposited on he PET film |
| | 23 using electron-beam deposition |
| 25 | PE lacquer laminate coating , 3 g/m³ |
| 26 | LMDPE-film, 90 μm thick. |

### EXAMPLE 3

The tube laminate shown in cross-section in FIG. 3 exhibits the following structure from the outside of the tube to the inside of the tube:

| 30a, b, c | coextruded PE film, ,transparent, 110 μm thick |
|---|---|
| 31a, b | PE extruded laminate layer, coextruded, transparent, 45/10 μm |
| | thick |
| 32 | aluminum, 70 nm thick, vapor deposited on to the micro- |
| | embossing M on PET film 33 |
| 33/M | micro-embossed PET film, 12 μm thick, |
| 34 | barrier layer of SiO_{1.8}, 80 nm thick, deposited on the PET |
| | film 33 by electron-beam vapor deposition |
| 35 | chrome layer as bonding agent, 0.5 nm thick, deposited by |
| | sputtering on to the barrier layer 34 |
| 36 | E.AA copolymer, 30 μm thick extruded laminate layer, |
| 37 | LMDPE-Film, 60 μm thick. |

### EXAMPLE 4

The tube laminate shown in cross-section in FIG. 4 exhibits the following structure from the outside of the tube to the inside of the tube:

| 40a, b, c | PE-film, co-extruded, transparent, 110 μm thick, |
|---|---|
| 41a, b | PE-extrusion laminated, co-extruded, transparent, 45/10 μm |
| 42 | thick aluminum, 70 nm thick, vapor-deposited on the micro- |
| | embossing M on the PET-film 43, |
| 43/M | micro-embossed PET-film, 12 μm thick, |
| 44 | E.AA-copolymer-Extrusion laminated, 30 μm thick, |
| 45 | aluminum foil, 20 μm thick, as barrier layer, |
| 46 | E.AA-copolymer-extrusion laminated, 30 μm thick, |
| 47 | LMDPE-film, 60 μm thick. |

### EXAMPLE 5

The cross-section through a tube laminate shown in FIG. 5 exhibits the following structure from the outside of the tube to the inside of the tube:

| 50a, b, c, d | coextruded PE-film, transparent, 110 μm thick, with partial |
|---|---|
| | layer 50d for the micro-embossing M, |
| 51 | aluminum, 70 nm thick, vapor deposited on the embossing |
| | on the partial layer 50d of the PE-flim, |
| 52a, b | PE-extrusion laminated, co-extruded, thickness 45/10 μm, |
| 53/M | aluminum foil, 20 μm thick, as barrier layer, |
| 54 | E.AA-copolymer, extrusion laminated, 30 μm thick, |
| 55 | LMDPE-film, 60 μm thick. |

1. Process for manufacturing a multi-layer tube material having a barrier layer (12, 24, 34, 45, 53) that hinders the passage of water vapor and gases, situated between plastic layers (10, 14; 20, 26; 30, 37; 40, 47; 50, 55), and exhibiting a pattern in one of the layers (12, 23, 33, 43, 50d) of the tube material, produced by an optical effect as a result of micro-embossing (M), in which process the individual layers are combined to make up the multi-layer tube material,
characterized in that,
one of the layers (12, 23, 33, 43, 50) in the form of a film is embossed and bonded to the other layers resulting in the said tube laminate.

2. Process according to claim 1, characterized in that the pattern producing an optical effect is a hologram.

3. Process according to claim 1 or 2, characterized in that the foil to be embossed is a metal foil (12) serving as a barrier layer, preferably an aluminum foil.

4. Process according to claim 1 or 2, characterized in that the foil to be embossed is a plastic film (23, 33) with a barrier layer (23, 33) on one side, preferably a ceramic coating of SiOₓ, whereby the side on the opposite side of the barrier film (23, 33) is embossed and a layer of metal (22, 32), preferably aluminum, is provided on the embossed pattern (M).

5. Process according to claim 1 or 2, characterized in that the foil to be embossed is a plastic film (43, 50d), and a layer of metal (42, 51), preferably aluminum, is provided on the embossed pattern (M), whereby a metal foil (45, 53) preferably an aluminum foil is provided as barrier layer.

6. Multi-layer tube material, manufactured using the process according to claim 3, characterized by way of the following structure:
at least one single-layer or multi-layer plastic layer (10) which is transparent at least in some areas,
a metal foil (12) with micro-embossing (M) on the side of the plastic layer (10), and
at least one functional layer (14) of a single-layer or multi-layer plastic layer.

7. Multi-layer tube material, manufactured using the process according to claim 4, characterized by way of the following structure:
at least one single-layer or multi-layer plastic layer (20, 30) which is transparent at least in some areas,
a plastic film (22,33) with a micro-embossing (M) and a layer of metal (22,33) on the embossed pattern (M) on the side of the plastic layer (20, 30) and with a barrier layer (24, 34) of SiOₓ on the side of the foil (23,33) opposite that bearing the micro-embossing (M) and,
at least one functional layer (26, 37) in the form of a single-layer or multi-layer plastic layer.

8. Multi-layer tube material according to claim 7, characterized in that the plastic layer bordering on the metal layer is a laminate layer (21) of lacquer.

9. Multi-layer tube material according to claim 7, characterized in that the plastic layer bordering on the metallic layer is an extrusion laminated layer.

10. Multi-layer tube material according to one of the claims 7 to 9, characterized in that a bonding agent (35), preferably a chrome layer, is provided on the barrier layer (34) of SiOₓ, and preferably an extrusion laminated layer (36) is provided between the bonding agent (35) and a functional layer (37).

11. Multi-layer tube material, manufactured using the process according to claim 5, characterized by way of the following structure:
at least one single-layer or multi-layer plastic layer (40, 50) which is transparent at least in some areas,
a plastic film (43, 50d) with micro-embossing (M) and on the side of the plastic layer (40, 50), a layer of metal (42, 51) on the embossed pattern (M),
at least one functional layer (47, 55) in the form of a single-layer or multi-layer plastic layer and,
a metal foil (45, 55), preferably an aluminum foil is provided as barrier layer between the embossed pattern (M) and the functional layer (47, 55).

12. Multi-layer tube material according to claim 11, characterized in that the plastic layer bordering on the metallic layer (42, 51) is a lacquer laminate layer or an extrusion laminate layer (41)

13. Multi-layer tube material according to claim 11 or 12, characterized in that a lacquer laminate layer or an extrusion laminate layer (42, 52) is provided between the plastic film (43, 50d) with the micro-embossing (M) and the metal foil (45, 53).

14. Multi-layer tube material according to one of the claims 11 to 13, characterized in that a lacquer laminate layer or an extrusion laminate layer (46, 54) is provided between the metal foil (45, 53) and a functional layer (47, 55).
